(19) United States
(12) Patent Application Publication
(10) Pub. No.: US 2008/0055524 A1
(43) Pub. Date: Mar. 6, 2008

(54) LIQUID CRYSTAL DISPLAY DEVICE

(75) Inventors: Atsuyuki Manabe, Fukaya-shi (JP); Hideyuki Takahashi, Fukaya-shi (JP); Kiyoshi Shohara, Saitama-shi (JP); Hiroharu Inoue, Fukaya-shi (JP); Tetsuyuki Yamada, Saitama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/778,206

(22) Filed: Jul. 16, 2007

(30) Foreign Application Priority Data
Aug. 31, 2006 (JP) 2006-235963

(51) Int. Cl. G02F 1/13; G02F 1/1333

(52) U.S. Cl. 349/106

(57) ABSTRACT

Provided is a liquid crystal display device that makes it possible to prevent coating unevenness of a colored layer from occurring. The liquid crystal display device includes a first colored layer, a second colored layer and a third colored layer, which layers are formed in a display area. In the liquid crystal display device, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m−1), (n−1, m+1), (n+1, m−1) and (n+1, m+1).

### CROSS-REFERENCE TO RELATED APPLICATIONS

This application is based upon and claims the benefit of priority from Japanese Patent Application No. 2006-235963 filed Aug. 31, 2006; the entire contents of which are incorporated herein by reference.

### BACKGROUND OF THE INVENTION

1. Field of the Invention

The present invention relates to a liquid crystal display device including a first colored layer, a second colored layer and a third colored layer.

2. Description of the Related Art

In recent years, as display devices used for various devices such as cellular phones and laptop computers, liquid crystal display devices have been widely used. A liquid crystal display device is configured of an allay substrate and a drive circuit for driving a plurality of scanning lines and a plurality of signal lines. On the array substrate, a pixel is arranged in each of intersections of the plurality of scanning lines and the plurality of signal lines. Each of the pixels includes a thin film transistor (TFT), a liquid crystal capacitor, an auxiliary capacitor and the like

In addition, as the integrated circuit technology has been developed and the process technology has been put into practical application, it is possible to form a part of the drive circuits on the array substrate. As a result, the size and the thickness of the liquid crystal display device have been reduced.

A first colored layer, a second colored layer and a third colored layer are disposed in a display area on the array substrate of such a liquid crystal display device. In addition, the first colored layer is formed in a vertical stripe pattern.

However, as array substrates have been enlarged more and more, coating unevenness due to the pattern of the first colored layer may possibly occur when the second colored layer is formed by coating, in a case of the first colored layer with a stripe pattern. This is because, with the enlargement of the array substrates, the number of same patterns arranged per array substrate has been increased, and also the array substrates have been made finer with a higher precision.

For the purpose of preventing the coating unevenness, it is effective to form the first colored layer in a grid pattern expanding in the vertical and horizontal directions, as described in Japanese Patent Application Publication No. 2001-337345. This pattern prevents a color liquid resist of the second colored layer from running only in one direction due to the first colored layer. As a result, coating unevenness such as an unintentional gap left in coating is unlikely to occur.

However, as the grid pattern becomes denser (finer), coating unevenness may occur in particular directions when the second colored layer is formed by coating. This is because the resistance that inhibits the expansion of the second colored layer in the centrifugal direction becomes larger due to the dense grid pattern formed in the first colored layer.

### SUMMARY OF THE INVENTION

An object of the present invention is to provide a liquid crystal display device that makes it possible to prevent coating unevenness of a colored layer from occurring, and to thus prevent a display quality from being deteriorated without decreasing the manufacturing yield.

A first aspect of the present invention provides a liquid crystal display device including a first colored layer, a second colored layer and a third colored layer, which layers are formed in a display area. In the liquid crystal display device according to the first aspect, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m−1), (n−1, m+1), (n+1, m−1) and (n+1, m+1).

A second aspect of the present invention provides a liquid crystal display device including a first colored layer, a second colored layer and a third colored layer, which layers are formed in a display area. In the liquid crystal display device according to the second aspect, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m), (n+1, m), (n−1, m−1), (n—1, m+1), (n+1, m−1) and (n+1, m+1).

A third aspect of the present invention provides a liquid crystal display device including a first colored layer, a second colored layer and a third colored layer, which layers are formed in a display area. In the liquid crystal display device according to the third aspect, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m), (n+1, m), (n−1, m−1), (n−1, m+1), (n−1, m+2), (n+1, m−1), (n+1, m+1) and (n+1,m+2), and concurrently a grid square is formed in a pixel of (n, m+1).

A fourth aspect of the present invention provides a liquid crystal display device including a first colored layer, a second colored layer and a third colored layer, which layers are formed in a display area. In the liquid crystal display device according to the fourth aspect, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m), (n+1, m), (n−1, m−1), (n−1, m+1), (n−1, m+2), (n−1, m+3), (n+1, m−1), (n+1, m+1), (n+1, m+2) and (n+1, m+3), and concurrently grid squares are formed in pixels of (n, m+1) and (n, m+2).

A fifth aspect of the present invention provides a liquid crystal display device including a first colored layer, a second colored layer and a third colored layer, which layers are formed in a display area. In the liquid crystal display device according to the fifth aspect, the first colored layer is arranged in a grid pattern in a manner of surrounding the second colored layer and the third colored layer. In addition, when (n, m) denotes the coordinates of a pixel having a grid square formed therein in the display area, grid squares are omitted in at least pixels of (n−1, m), (n+1, m), (n−1, m−1), (n+1, m−1), (n−1, m+1), (n−1, m+2), . . . , (n−1, m+a (a is an integer not less than 3)), (n−1, m+a+1), (n+1, m+1), (n+1, m+2), . . . , (n+1, m+a) and (n+1, m+a+1), and concurrently grid squares are formed in pixels of (n, m+1), (n, m+2), . . . , (n, m+a).

### BRIEF DESCRIPTION OF THE DRAWINGS

FIG. 1 is a configurational view of a liquid crystal display device according to an embodiment.

FIG. 2 is an overview showing a display area and also the entire configuration of the liquid crystal display device according to the embodiment.

FIG. 3 shows an example of a mask pattern for a first colored layer according to a first embodiment.

FIG. 4 shows a grid mask pattern of the first colored layer as a comparative example.

FIG. 5 shows a stripe mask pattern of the first colored layer as another comparative example.

FIG. 6 is an explanatory view for explaining a process of applying a color liquid resist to a mask pattern.

FIG. 7 is another explanatory view for explaining the process of applying the color liquid resist to the mask pattern.

FIG. 8 shows an example of coating unevenness that occurs in the case of the mask pattern shown in FIG. 5.

FIG. 9 shows an example of display unevenness that occurs in the case of the mask pattern shown in FIG. 4.

FIG. 10 is a comparison table showing occurrence rates of unevenness between the mask pattern of the first embodiment and the mask pattern shown in FIG. 4.

FIG. 11 shows an example of a mask pattern for a first colored layer according to a second embodiment.

### DESCRIPTION OF THE EMBODIMENT

### First Embodiment

Descriptions will be given below of a first embodiment of the present invention with reference to the accompanying drawings.

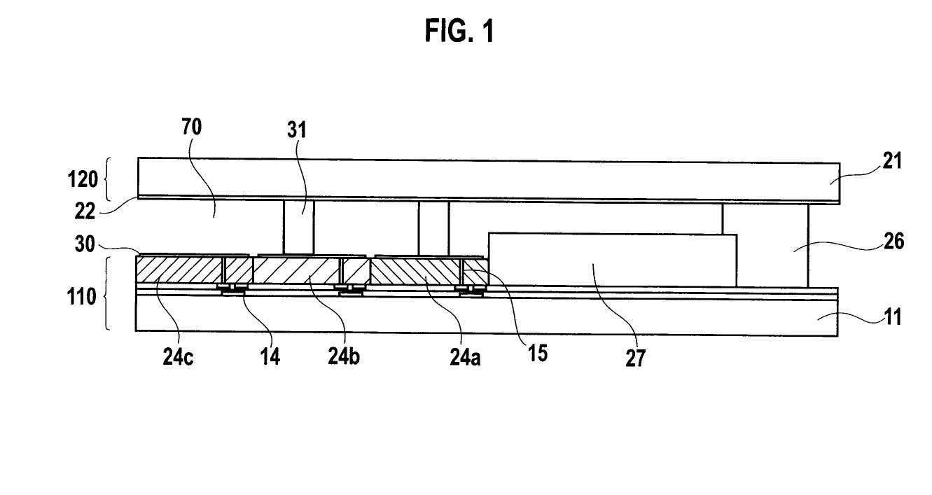

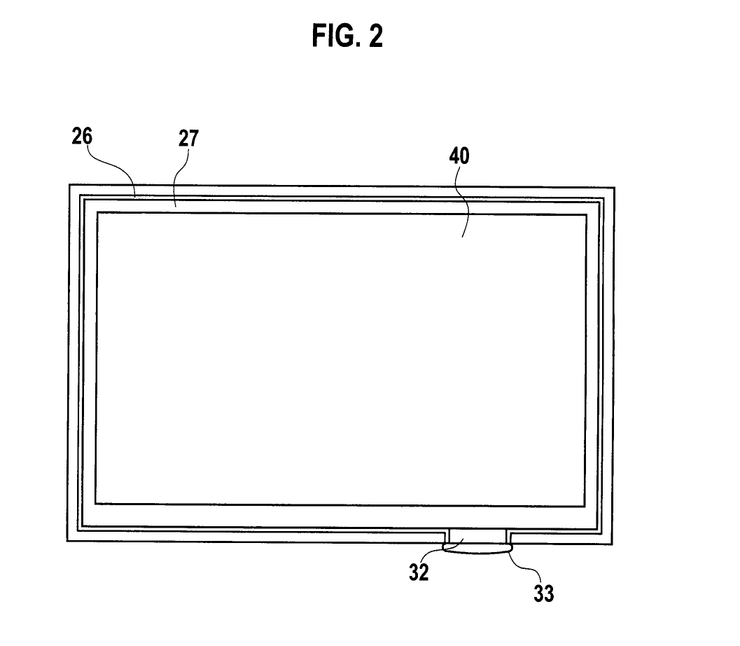

FIG. 1 is a configurational view of a liquid crystal display device according to an embodiment of the present invention. FIG. 2 is an overview showing a display area and also the entire configuration of the liquid crystal display device according to the embodiment. As shown in FIG. 1, the liquid crystal display device includes an array substrate 110 and an opposite substrate 120. The array substrate 110 includes colored layers 24a, 24b and 24c. A liquid crystal layer 70 is held between the array substrate 110 and the opposite substrate 120. The distance between the array substrate 110 and the opposite substrate 120 is maintained by columnar spacers 31 each formed of resin.

As shown in FIG. 2, the opposite substrate 120 and the array substrate 110 are bonded to each other with a seal 26, which is disposed in a manner of surrounding the outer periphery of the substrates except a portion of a liquid crystal inlet 32. A sealing member 33 is applied to the liquid crystal inlet 32.

Switching elements 14 are formed on a transparent insulating substrate 11 in the array substrate 110. The first colored layers 24a, the second colored layers 24b and the third colored layers 24care disposed on the switching elements 14. Transparent pixel electrodes 30 are formed on each of the colored layers 24a, 24b and 24c, and are connected to the switching elements 14 via corresponding through holes 15. In addition, an unillustrated alignment layer is disposed on the transparent pixel electrodes 30.

The opposite substrate 120 includes: a transparent insulating substrate 21; a transparent electrode 22 made of ITO (tin-doped iridium oxide: a transparent conductive film) and disposed on the transparent insulating substrate 21; and an alignment film (not illustrated) disposed on the transparent electrode 22. With above-described structure, a display area 40 for displaying an image is formed, and a BM (black matrix) layer 27 is formed on the outer periphery of the display area 40.

It should be noted that a pixel (not illustrated) is disposed on each of intersections of a plurality of scanning lines and a plurality of signal lines in the display area 40 of the liquid crystal display device. Each pixel includes the first colored layer 24a, the second colored layer 24b and the third colored layer 24c, and the display area 40 is configured of an aggregate of the pixels each taken as the minimum unit.

Next, descriptions will be given of a process for manufacturing the liquid crystal display device according to the embodiment.

Firstly, a process for manufacturing the array substrate 110 will be described.

The switching elements are formed on the transparent insulating substrate 11, and then a red liquid resist is applied by spin coating to the surface of the transparent insulating substrate 11 with the switching elements formed thereon. The resultant substrate thus coated is pre-baked at a temperature of approximately 90° C. for approximately 5 minutes. The resultant substrate thus pre-baked is then exposed to ultraviolet rays with an intensity of 150 mJ/cm² by using a predetermined mask pattern.

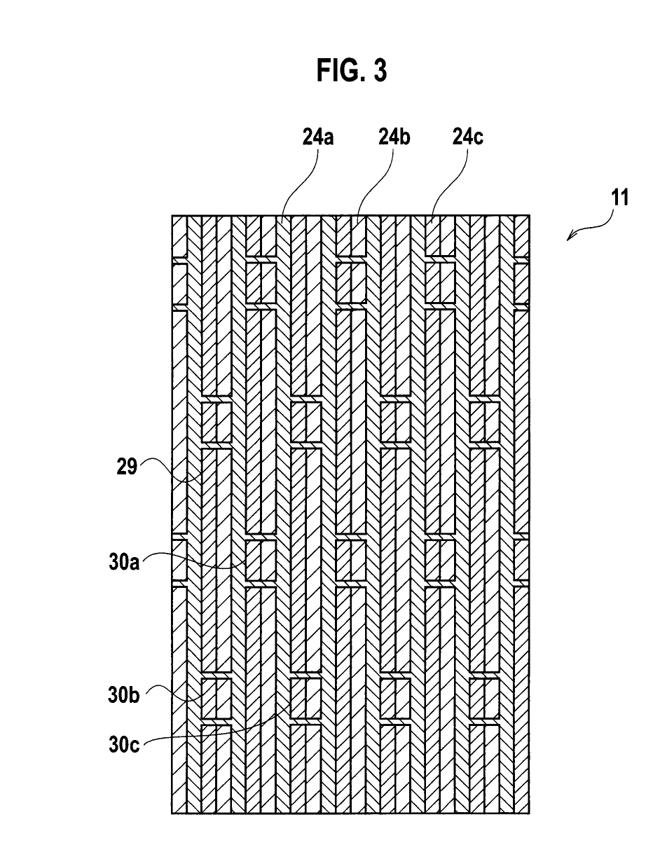

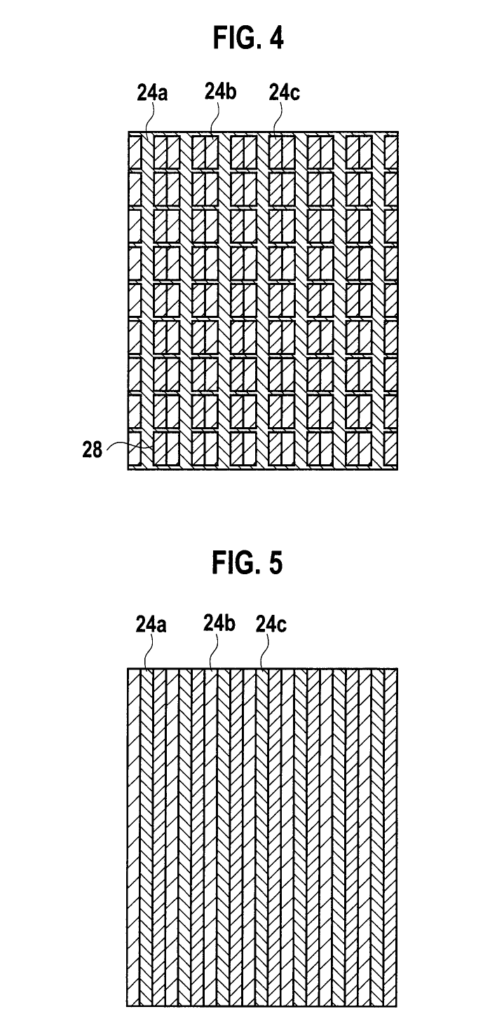

FIG. 3 shows an example of a mask pattern for the first colored layer 24a of this embodiment. The mask pattern shown in FIG. 3 is formed by omitting grid squares 28 of predetermined pixels from a grid pattern shown in FIG. 4. In the grid pattern shown in FIG. 4, the first colored layer 24a expands in the vertical and horizontal directions in a manner of surrounding the second and third colored layers 24b and 24c, so that a grid square is disposed in each pixel unit.

In the mask pattern of this embodiment shown in FIG. 3, grid squares are omitted in 5 out of every 6 pixels in the vertical direction (denoted by reference numeral 29). In addition, in the mask pattern shown in FIG. 3, each pixel in which a grid is omitted is displaced with respect to pixels in the adjacent lines each extending in the vertical direction, so that pixels in which grid squares are formed are not successively positioned side by side in the horizontal direction. In other words, a grid 30a is arranged in a manner that the grid 30a is not adjacent to grid squares 30b and 30c in the adjacent lines.

Specifically, when (n, m) denotes the coordinates of a pixel having a grid square formed therein, grid squares are not formed, that is, grids are omitted from pixels of (n−1, m−2), (n−1, m−1), (n−1, m), (n−1, m+1), (n−1, m+2), (n+1, m−2) (n+1, m−1), (n+1, m), (n+1, m+1) and (n+1, m+2).

In terms of the application of a color liquid resist by spin coating, when the size of the transparent insulating substrate 11 is approximately 400 mm square, it is possible to obtain a favorable coating result. Moreover, the size of the transparent insulating substrate 11 is sometimes larger than the above one in accordance with the application of the liquid crystal display device. In such a case, it is preferable that the size of the transparent insulating substrate 11 be approximately 800 to 900 mm square or more.

Subsequently, the resist thus applied is developed for approximately 40 minutes by using an aqueous solution of approximately 0.1 percent by weight of TMAH (tetramethylammonium hydroxide). Then, the resultant resist thus developed is washed with water, and is then post-baked for approximately 1 hour at a temperature of approximately 200° C., so that a red colored layer, which is the first colored layer 24a, is formed.

After that, the second colored layer 24b and the third colored layer 24c are formed respectively by use of a blue liquid resist and a green liquid resist in the same process as that of the case of the first colored layer 24a.

Thereafter, ITO (tin-doped indium oxide: a transparent conductive film) is deposited on the colored layers 24a, 24b and 24c by means of a sputtering method, followed by patterning, so that the transparent pixel electrodes 30 are formed.

A light shield (the BM layer) is formed by using a black resin in the same way as those of the colored layers 24a, 24b and 24c, and columnar spacers 31 are then formed by using a transparent resin. Thereafter, a material for the alignment layer, which is made of polyimide, is applied to the entire surface of the substrate, and the alignment layer is formed by performing an alignment treatment thereon. Consequently, the array substrate 110 is manufactured.

Next, descriptions will be given below of a process for manufacturing the opposite substrate 120.

ITO is deposited on the transparent insulating substrate 21 by means of the sputtering method so as to form the transparent electrode 22. Then, the material for the alignment layer, which is made of polyimide, is applied to the entire surface of the substrate, and the alignment layer is formed by performing the alignment treatment thereon. Consequently, the opposite substrate 120 is manufactured.

Next, the seal 26 is applied to a vicinity of the outer periphery of the opposite substrate 120 except the portion of the inlet 32 for injecting a liquid crystal (refer to FIG. 2). Then, the opposite substrate 120 and the array substrate 110 are bonded to each other with the seal 26. The substrates thus bonded are placed in a sealing device of a single wafer processing type, so that air is evacuated. The substrates are baked for 30 minutes at a curing temperature of approximately 170° C., so that an empty cell is formed.

Subsequently, a nematic liquid crystal material to which a chiral material is added is injected into the cell from the inlet 32 in a vacuum state. After the injection, the inlet 32 is sealed by using an ultraviolet curing resin serving as the sealing material 33, and then polarizing plates are disposed on both sides of the cell. Consequently, the liquid crystal display device is completed.

FIG. 5 shows a comparative example of this embodiment. In this example, the first colored layer 24a, the second colored layer 24b and the third colored layer 24c are formed into vertical stripes. In a case where the first colored layer 24a has a stripe pattern, coating unevenness may possibly occur at the time of coating the second colored layer 24b due to the pattern of the first colored layer 24a.

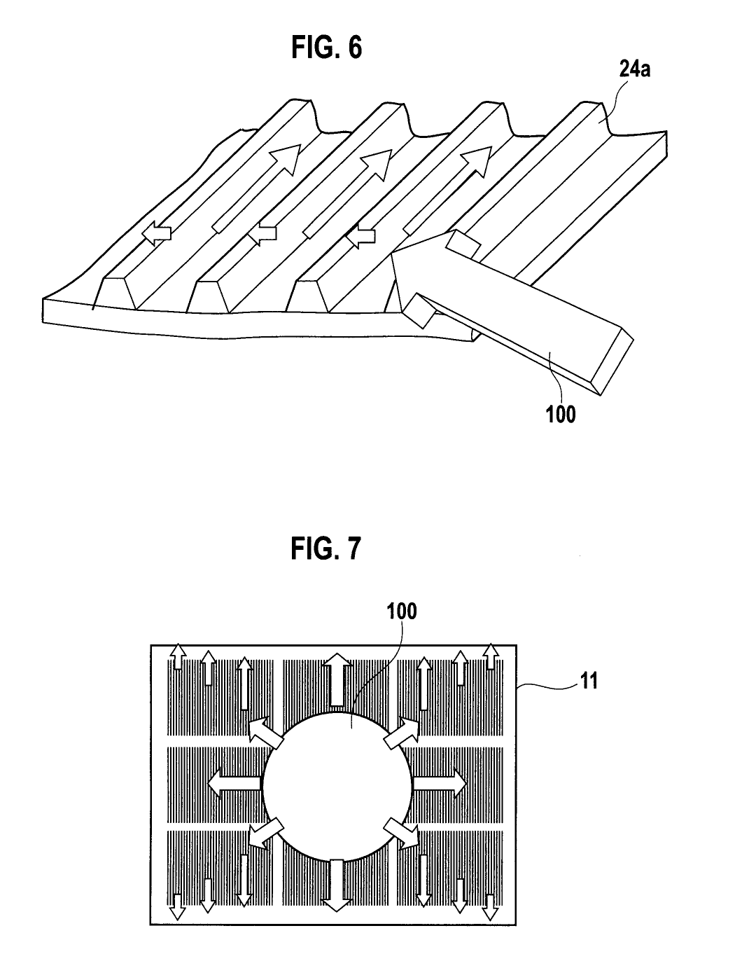

Specifically, the first colored layer 24a is formed with the stripe pattern in the first process for manufacturing a liquid crystal display device, and then the second colored layer 24b is formed on the first colored layer 24a by using the spin coater (the spin coating method) in the next process. At this time, as shown in FIG. 6, a color resist 100, which has not yet been cured, and which thus has fluidity, of the second colored layer 24b may possibly run by the centrifugal force along the marginal portions of the stripe pattern formed in the first colored layer 24a.

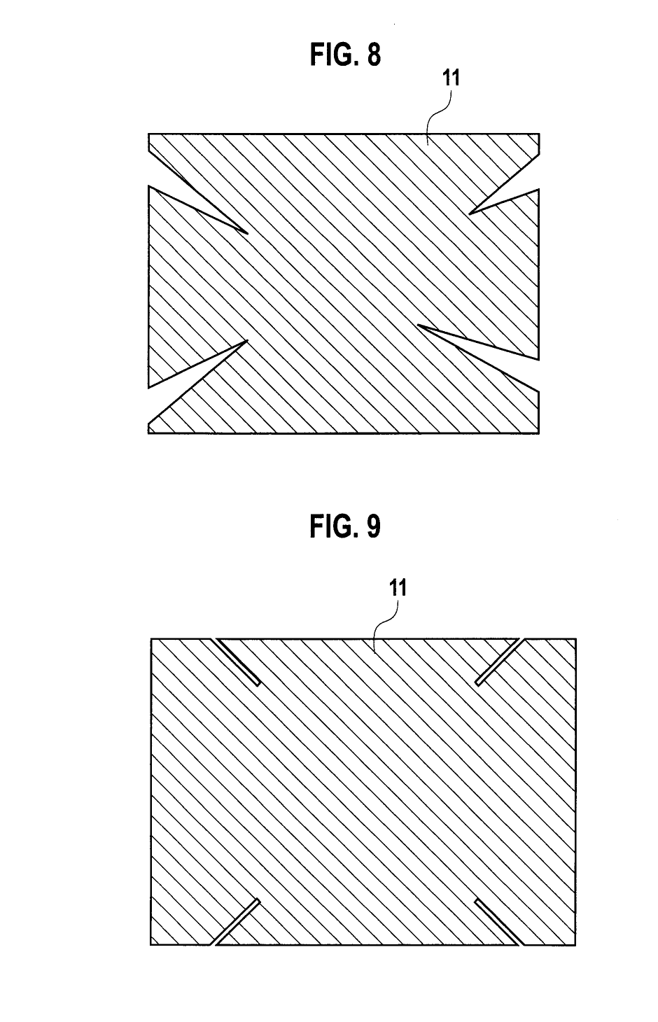

In particular, on a chip disposed on a vicinity of a resist substrate, as shown in FIG. 7, the color resist 100 of the second colored layer runs to expand in directions other than the direction of the centrifugal force. As a result, unintentional gaps left in coating expanding from corner portions of the chip are formed in the second colored layer, as shown in FIG. 8.

In addition, suppose a case where the first colored layer has the grid pattern expanding in the vertical and horizontal directions, as shown in FIG. 4. In this case, as the grid pattern becomes denser (finer), the resistance that inhibits the expansion of the second colored layer in the centrifugal direction becomes larger due to the grid pattern formed in the first colored layer, when the second colored layer is formed by coating. Accordingly, coating unevenness occurs in particular directions, for example, in diagonal directions of the grid pattern as shown in FIG. 9.

The angle at which the coating unevenness occurs is largely affected by the alignment and the pixel pitch of the grid pattern. This is because the number of grid squares to be run over by the resist in each unit distance increases. In the case of the grid pattern shown in FIG. 4, the grid pattern is aligned in a direction inclined at approximately 45°.

When a color resist is applied by the spin coater, as shown in FIG. 7, the color resist 100 runs in all directions on the transparent insulating substrate 11 by the centrifugal force. However, when the grid pattern of the first colored layer is aligned in a certain angular direction, the resistance in the alignment direction is increased, so that the color resist does not run very well. Accordingly, the thickness of the coated film of the second colored layer 24b is reduced, so that coating unevenness is recognized.

On the other hand, the liquid crystal display device according to this embodiment has a structure in which some of grid squares of the first colored layer are omitted, and in which each of the grid squares is thus not adjacent to other grid squares. With this structure, this embodiment makes it possible to prevent the coating unevenness as shown in FIG. 8 from occurring as well as the display unevenness as shown in FIG. 9 from occurring. For this reason, according to this embodiment, it is possible to obtain a uniform and favorable image quality. And it is also possible to prevent a reduction in the yield associated with the occurrence of the coating unevenness and the display unevenness.

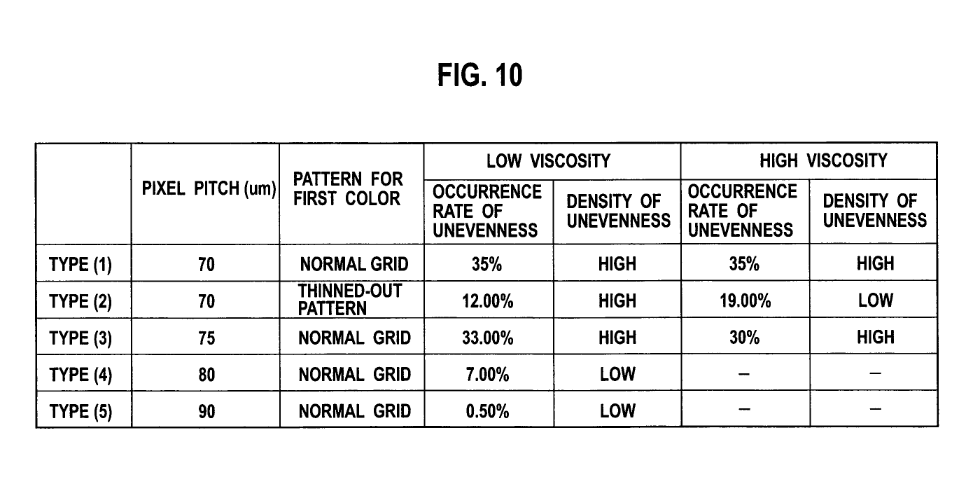

FIG. 10 is a comparison table showing occurrence rates of unevenness between the mask pattern, in which grid squares are omitted, according to this embodiment shown in FIG. 3 and the mask pattern (hereinafter, referred to as a normal grid pattern), in which first colored layer as shown in FIG. 4 expands in the vertical and horizontal directions. In the comparison table shown in FIG. 10, types (1) to (5) are shown as kinds of mask patterns. The type (2) is the mask pattern of this embodiment of FIG. 3, while the types (1) and (3) to (5) are the normal grid mask patterns of FIG. 4.

In the case of the mask pattern of the first colored layer in which the pixel pitch is 70 μm, when a color liquid resist having a low viscosity is used, the type (1) of the normal grid pattern has an occurrence rate of unevenness of 35%, while the type (2) of this embodiment has an improved occurrence rate of unevenness of 12.00%.

Even when a color liquid resist having a high viscosity is used, the type (1) of the normal grid pattern has an occurrence rate of unevenness of 35%, while the type (2) of this embodiment has an improved occurrence rate of unevenness of 19.00%.

Even the type (3) of the normal grid pattern in which the pixel pitch is 75 μm has an occurrence rate of unevenness of 33.00% when a color liquid resist having a low viscosity is used, and has an occurrence rate of unevenness of 30% when a color liquid resist having a high viscosity is used. On the other hand, the type (2) of this embodiment has the improved occurrence rates of unevenness of 12.00% and 19.00%.

Incidentally, by setting the pixel pitch at a large value, such as 80 μm of the type (4), or 90 μm of the type (5), it is also possible to reduce the occurrence rate of unevenness to a low value, such as 7.00% and 0.50%. However, when the pixel pitch is set at a large value, it is difficult to achieve a fine image quality, which can be achieved by using a fine pixel pitch, such as 70 μm.

In the first embodiment, the mask pattern of the first colored layer 24a shown in FIG. 3 is used, but another mask pattern may also be used. For example, a mask pattern may be used, in which grid squares are omitted in at least pixels of (n−1, m−1), (n−1, m+1), (n+1, m−1) and (n+1, m+1) when (n, m) denotes the coordinates of a pixel having a grid square formed therein.

Alternatively, another mask pattern may be used, in which grid squares are omitted in at least pixels of (n−1, m), (n+1, m), (n−1, m−1), (n−1, m+1), (n+1, m−1) and (n+1, m+1) when (n, m) denotes the coordinates of a pixel having a grid square formed therein.

Even by using one of these patterns, it is possible to prevent coating unevenness of colored layers from occurring as in the case of the first embodiment. Accordingly, it is possible to prevent deterioration of image quality, and to thus provide a liquid crystal display device with a high yield.

### Second Embodiment

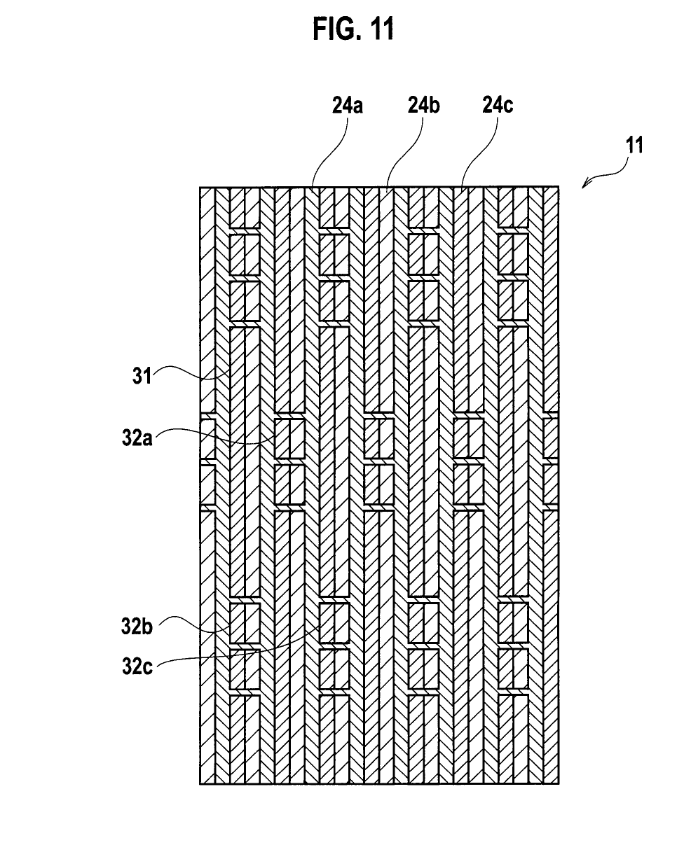

FIG. 11 shows an example of a mask pattern of the first colored layer 24a of this embodiment. The mask pattern shown in FIG. 11 is formed by omitting the grid squares 28 of predetermined pixels from a grid pattern shown in FIG. 4.

In the mask pattern of this embodiment, as shown in FIG. 11, grid squares are omitted in 6 out of every 8 pixels in the vertical direction (denoted by reference numeral 31). In addition, in the mask pattern shown in FIG. 11, each pixel in which a grid is omitted is displaced with respect to pixels in the adjacent lines each extending in the vertical direction, so that pixels in which grid squares are formed are not successively positioned side by side in the horizontal direction. In other words, a grid 32a is arranged in a manner that the grid 32a is not adjacent to grid squares 32b and 32c in the adjacent lines.

Specifically, when (n, m) denotes the coordinates of a pixel having a grid square formed therein, grid squares are omitted in pixels of (n−1, m−2), (n−1, m−1), (n−1, m), (n−1, m+1), (n−1, m+2), (n−1, m+3), (n+1, m−2), (n+1, m−1), (n+1, m), (n+1, m+1), (n+1, m+2) and (n+1, m+3), and concurrently grid squares are formed in pixels of (n, m+1).

Since the configuration and manufacturing method of a liquid crystal display device of the second embodiment are the same as those of the first embodiment, descriptions of those are omitted.

The liquid crystal display device of the second embodiment has a structure in which some of grid squares of the first colored layer are omitted, and that each of the grid squares is thus not adjacent to other grid squares. With this structure, this embodiment makes it possible to prevent the coating unevenness as shown in FIG. 8 as well as the display unevenness as shown in FIG. 9 from occurring. For this reason, according to this embodiment, it is possible to obtain a uniform and favorable image quality. And it is also possible to prevent a reduction in the yield associated with the occurrence of the coating unevenness and the display unevenness.

In the second embodiment, the mask pattern of the first colored layer 24a shown in FIG. 11 is used, but another mask pattern may also be used. For example, when (n, m) denotes the coordinates of a pixel having a grid square formed therein, a mask pattern may be used in which grid squares are omitted in at least pixels of (n−1, m), (n+1, m), (n−1, m−1), (n−1, m+1), (n−1, m+2), (n+1, m−1), (n+1, m+1) and (n+1, m+2), and concurrently in which a grid square is formed in a pixel of (n, m+1).

Alternatively, another mask pattern may be used, in which grid squares are omitted in at least pixels (n−1, m), (n+1, m), (n−1, m−1), (n−1, m+1), (n−1, m+2), (n−1, m+3), (n+1, m1), (n+1, m+1), (n+1, m+2) and (n+1, m+3) when (n, m) denotes the coordinates of a pixel having a grid square formed therein, and concurrently in which grid squares are formed in pixels of (n, m+1) and (n, m+2).

Otherwise, still another mask pattern may be used, in which grid squares are omitted in at least pixels of (n−1, m), (n+1, m), (n−1, m−1), (n+1, m−1), (n−1, m+1), (n−1, m+2), . . . , (n−1, m+a (a is an integer not less than 3)), (n−1, m+a+1), (n+1, m+1), (n+1, m+2), . . . , (n+1, m+a) and (n+1, m+a+1) when (n, m) denotes the coordinates of a pixel having a grid square formed therein, and concurrently in which grid squares are formed in pixels of (n, m+1), (n, m+2), . . . , (n, m+a).

Even by using one of these patterns, it is possible to prevent coating unevenness of colored layers from occurring as in the cases of the first and second embodiments. Accordingly, it is possible to prevent deterioration of image quality, and to thus provide a liquid crystal display device with a high yield.

What is claimed is:

1. A liquid crystal display device comprising a first colored layer, a second colored layer and a third colored layer, which layers are formed in a display area, wherein
the first colored layer is arranged in a grid pattern in a manner of surrounding the second colored layer and the third colored layer, and
when (n, m) denotes the coordinates of a pixel having a grid square formed therein in the display area, grid squares are omitted in at least pixels of (n−1, m−1), (n−1, m+1), (n+1, m−1) and (n+1, m+1).

2. A liquid crystal display device comprising a first colored layer, a second colored layer and a third colored layer, which layers are formed in a display area, wherein
the first colored layer is arranged in a grid pattern in a manner of surrounding the second colored layer and the third colored layer, and
when (n, m) denotes the coordinates of a pixel having a grid square formed therein in the display area, grid squares are omitted in at least pixels of (n−1, m), (n+1, m), (n−1, m−1), (n−1, m+1), (n+1, m−1) and (n+1, m+1).

3. A liquid crystal display device comprising a first colored layer, a second colored layer and a third colored layer, which layers are formed in a display area, wherein
the first colored layer is arranged in a grid pattern in a manner of surrounding the second colored layer and the third colored layer, and
when (n, m) denotes the coordinates of a pixel having a grid square formed therein in the display area, grid squares are omitted in at least pixels of (n−1, m), (n+1, m), (n−1, m−1), (n−1, m+1), (n−1, m+2), (n+1, m−1), (n+1, m+1) and (n+1, m+2), and concurrently a grid square is formed in a pixel of (n, m+1).

4. A liquid crystal display device comprising a first colored layer, a second colored layer and a third colored layer, which layers are formed in a display area, wherein
the first colored layer is arranged in a grid pattern in a manner of surrounding the second colored layer and the third colored layer, and
when (n, m) denotes the coordinates of a pixel having a grid square formed therein in the display area, grid squares are omitted in at least pixels of (n−1, m), (n+1, m), (n−1, m−1), (n−1, m+1), (n−1, m+2), (n−1, m+3), (n+1, m−1), (n+1, m+1), (n+1, m+2) and (n+1, m+3), and concurrently grid squares are formed in pixels of (n, m+1) and (n, m+2).

5. A liquid crystal display device comprising a first colored layer, a second colored layer and a third colored layer, which layers are formed in a display area, wherein
the first colored layer is arranged in a grid pattern in a manner of surrounding the second colored layer and the third colored layer, and
when (n, m) denotes the coordinates of a pixel having a grid square formed therein in the display area, grid squares are omitted in at least pixels of (n−1, m), (n+1, m), (n−1, m−1), (n+1, m−1), (n−1, m+1), (n−1, m+2), . . . , (n−1, m+a (a is an integer not less than 3)), (n−1, m+a+1) , (n+1, m+1), (n+1, m+2), . . . , (n+1, m+a) and (n+1, m+a+1), and concurrently grid squares are formed in pixels of (n, m+1), (n, m+2), . . . , (n, m+a).
